(19) United States
(12) Patent Application Publication
(10) Pub. No.: US 2011/0232848 A1
(43) Pub. Date: Sep. 29, 2011

(54) ARRANGEMENT IN TIRE RETREADING ROLLING MACHINE FOR TIRES RECAPPING

(76) Inventor: Lucas MÖLLER, Sao Leopoldo (BR)

(21) Appl. No.: 13/025,248

(22) Filed: Feb. 11, 2011

(30) Foreign Application Priority Data
Feb. 24, 2010 (BR) MU9000242-3

(51) Int. Cl. B29D 30/00; B32B 37/00

(52) U.S. Cl. 156/394.1

(57) ABSTRACT

The present disclosure relates to an arrangement in a tire retreading rolling machine including a structure composed of a lower frame (Q) provided with adjustable feet (P) and one column (C) on one of its vertices. Column (C) has on its outer side a motoreducer set (MR) which rotates a hub (CB) positioned on the column inner side. A bearing (M) held to column (C) supports the hub (CB) shaft, on which the tire to be processed is mounted. The rolling device mounted on the frame (Q) comprises arms (1) with end rolls (2), on which the tire is rested on the wheeling position. The rolls (2) press the new tread against the tire carcass, expelling the air that may have been trapped. The arms (1) are centrally pivoting in transversal gears (3), by the action of cylinders (4), allowing to get rolls (2) closer or farther to/from the new tread applied to the tire carcass. Secondary rolls (5) with semi-spherical shape, are positioned on the arms ends (1) from the outside, and close to the main rolls (2), so as to exert pressure also on the tread sides, next to the tire shoulder. A horizontal spindle (6) is driven by a motor (7) and reducer (8) set, and is intended to move the arms (1), making the secondary rolls (5) exert pressure against the tire shoulders. The gears (3) are mounted over the bearings (9) sliding on the machine busbars (10), causing the rolls (2) and the secondary rolls (5) to exert pressure throughout the tread, including the shoulders area.

### BACKGROUND OF THE INVENTION

The present utility model relates to a novel building arrangement introduced in a tire retreading rolling machine used for tires recapping.

During the tires recapping process, an operation named rolling is performed, which consists in applying pressure for adhering a new tread to the carcass of the tire being recovered. While this operation is performed, the air that might be trapped between the tread and the tire carcass must be totally expelled. Otherwise, perfect parts adhesion will not occur, causing loss of tread parts during vehicle running.

Conventional tire retreading rolling machines are machines equipped with a rotating device, which receives a rim to which a tire carcass is mounted, with a tread already applied to it, and an arm with an extreme roll pressing the tread center strip against the tire carcass, thereby expelling the air that might have been trapped between the layers.

Examples of tire retreading rolling machines are found in patent documents MU 7400795-5, MU 7800332-6 and MU 8700907-2.

However, the operation of the tire retreading rolling machines is limited to the tread center strip, thus, proper pressing of the tire shoulder does not occur, i.e., the transition between the tire tread and flank. Such fact may result in failing adhesion on that tire area, jeopardizing the recapping process.

### SUMMARY OF THE INVENTION

Thus, an objective of the present utility model is a novel building arrangement introduced in a tire retreading rolling machine, overcoming said limitations in the state-of-the-art. The arrangement in the tire retreading rolling machine comprises, in addition to conventional rolls, a pair of secondary rolls, having a semi-spherical shape, which are laterally positioned, in such a way to exert transversal pressure on the tread. Secondary spherical rolls perform more accurate and smoother rolling on tire shoulders area, where the tread thickness is thinner, requiring smoother rolling with more directed outline. Thus, it is possible to apply appropriate pressure to all parts of the tread, minimizing the lack of adhesion problem in the tire carcass.

### BRIEF DESCRIPTION OF THE DRAWINGS

The arrangement in the tire retreading rolling machine proposed by the present utility model, is hereon described in detail, based on the enclosed drawings, listed below:

FIG. 1—perspective of the tire retreading rolling machine incorporating the rolling device;

FIG. 2—perspective of the rolling device isolated from the machine;

FIG. 3—front view of the rolling device;

FIG. 4—left side view of the rolling device;

FIG. 5—right side view of the rolling device;

FIG. 6—upper view of the rolling device;

FIG. 7—lower view of the rolling device.

### DESCRIPTION OF PREFERRED EMBODIMENTS

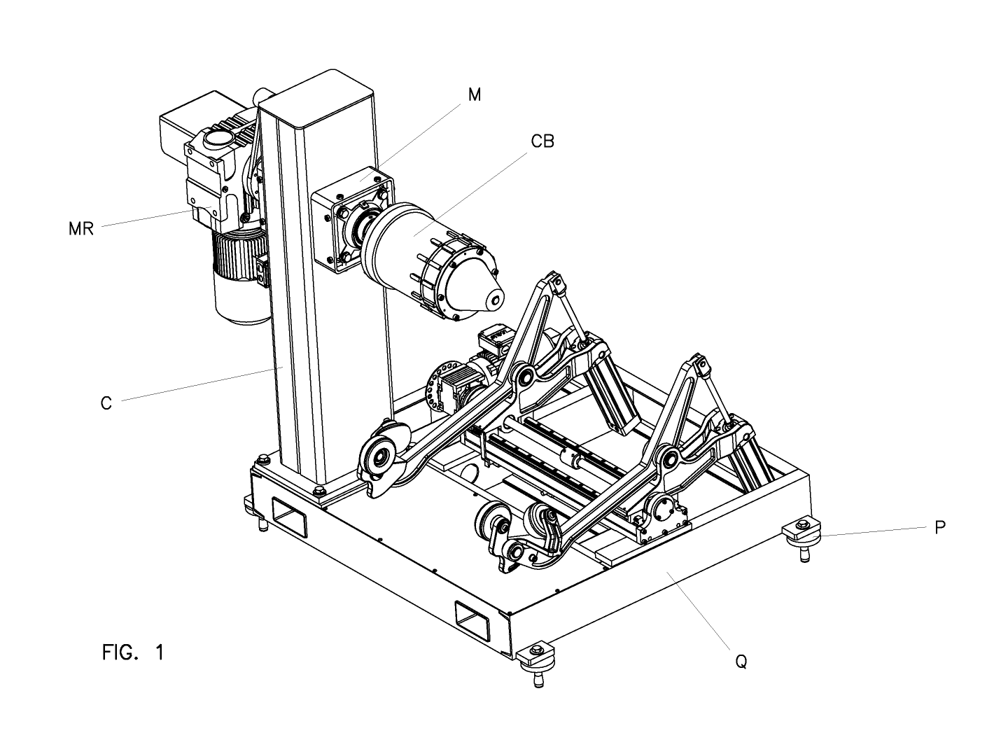

FIG. 1 shows the tire retreading rolling machine comprising the rolling device object of the present utility model and comprising a structure composed of a lower frame (Q) provided with adjustable feet (P) and one column (C) on one of its vertices. The column (C) has on its outer side a motoreducer set (MR) which rotates a hub (CB) positioned on the column inner side. A bearing (M), held to the column (C), supports the hub (CB) shaft, on which the tire to be processed is mounted.

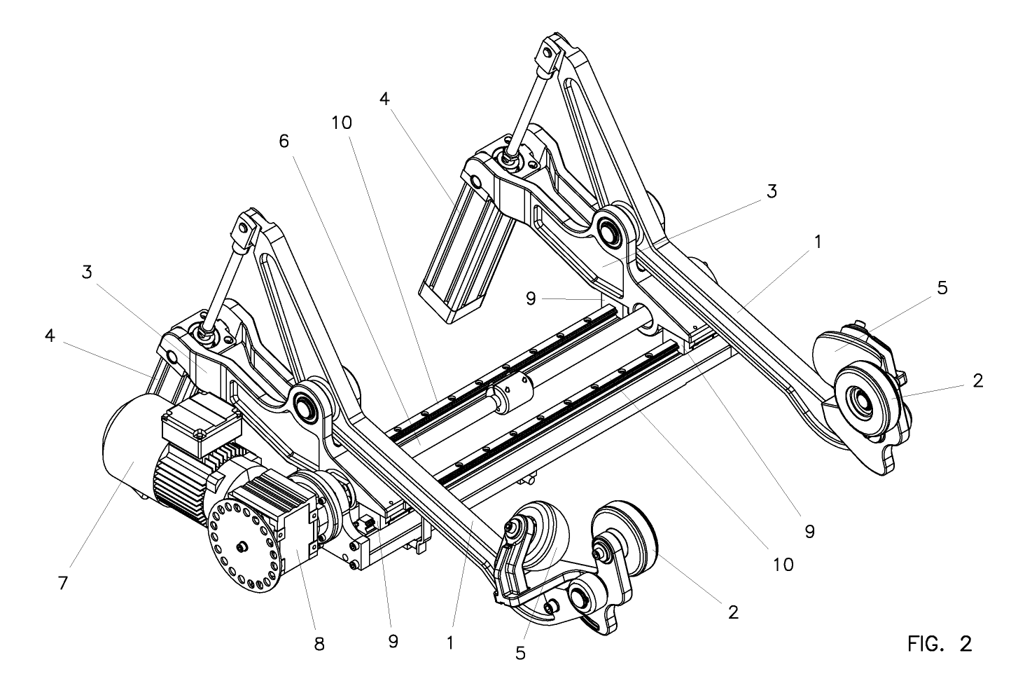

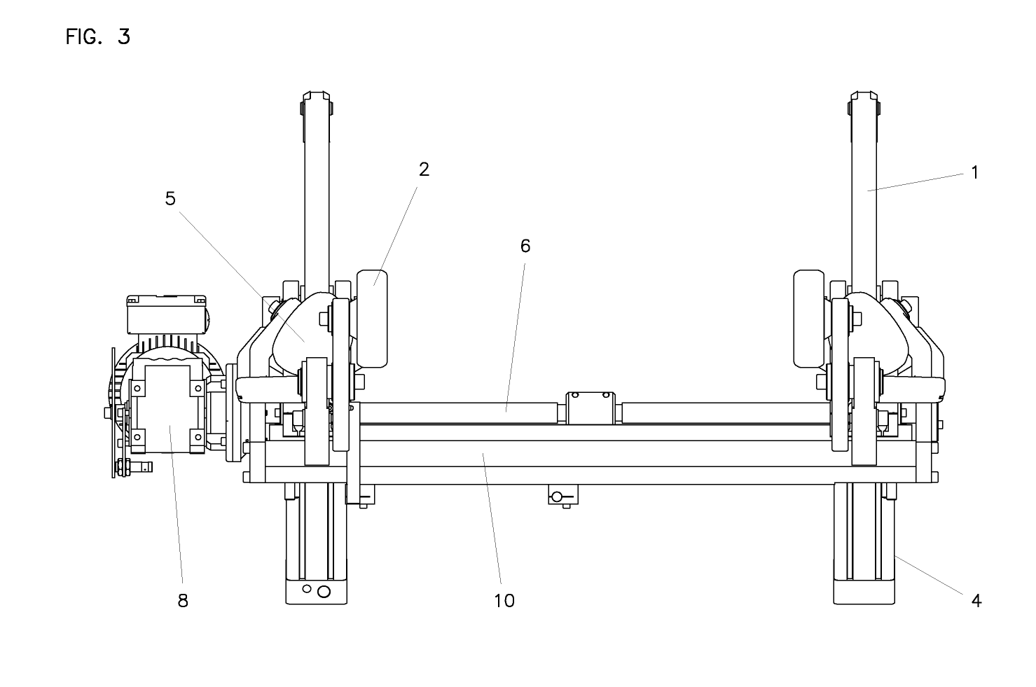

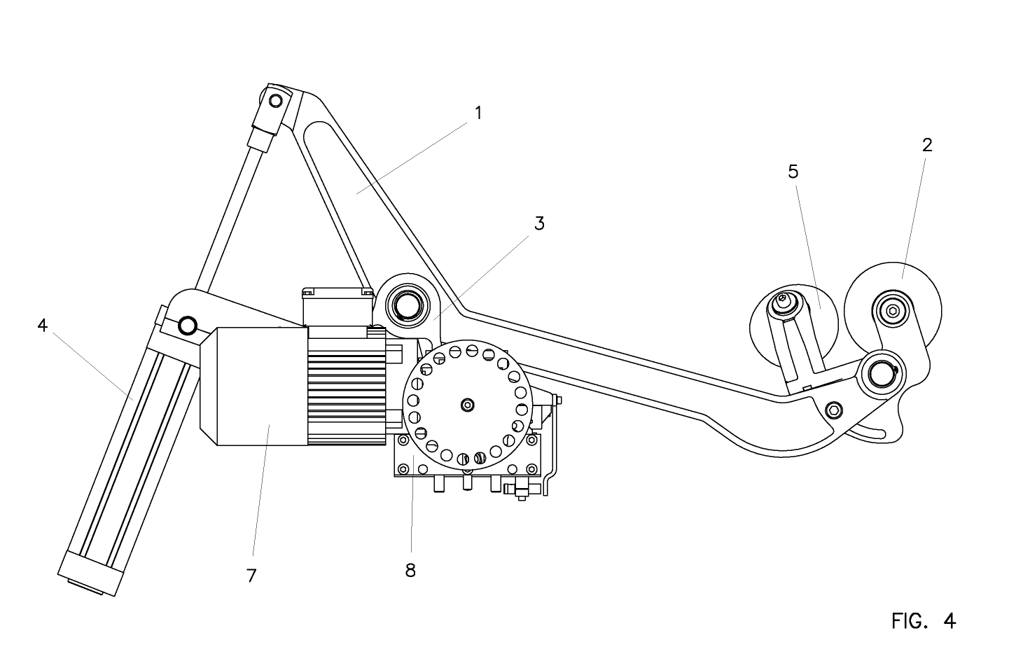

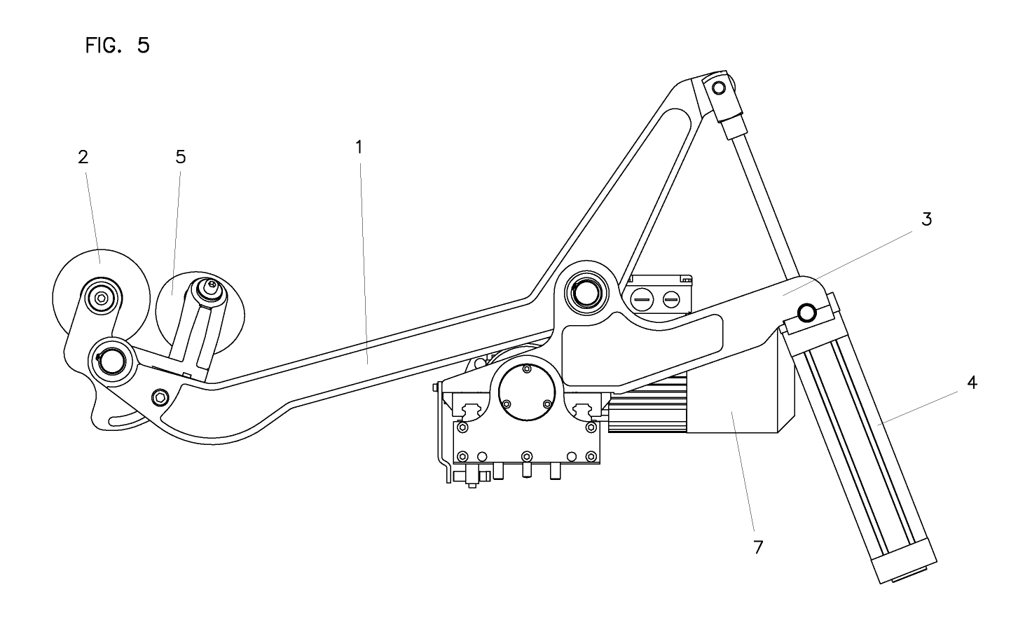

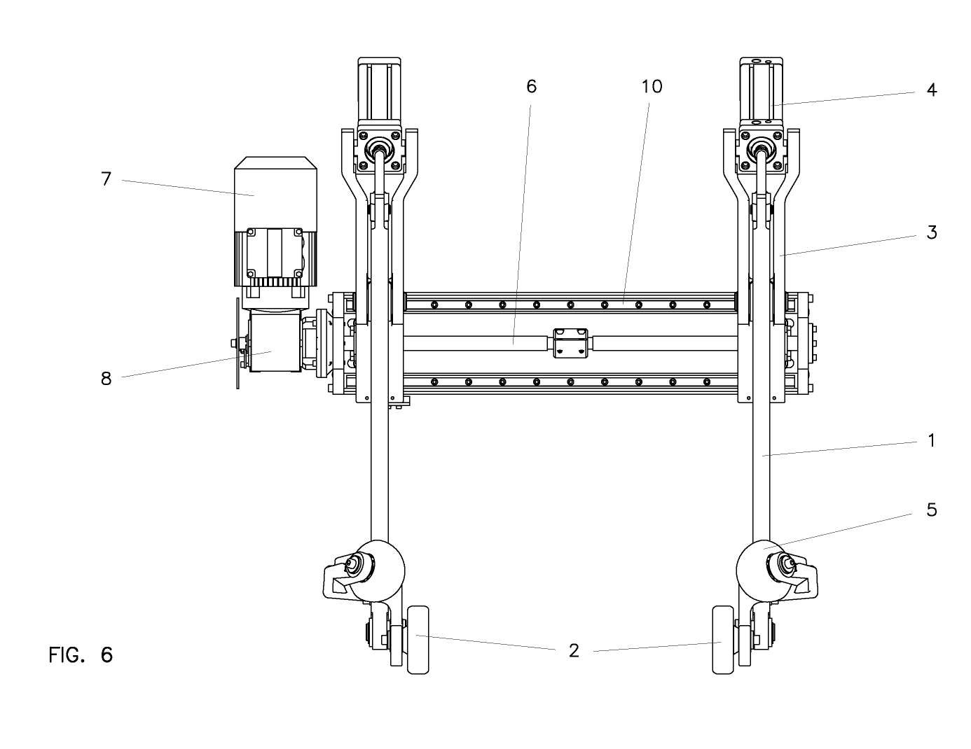

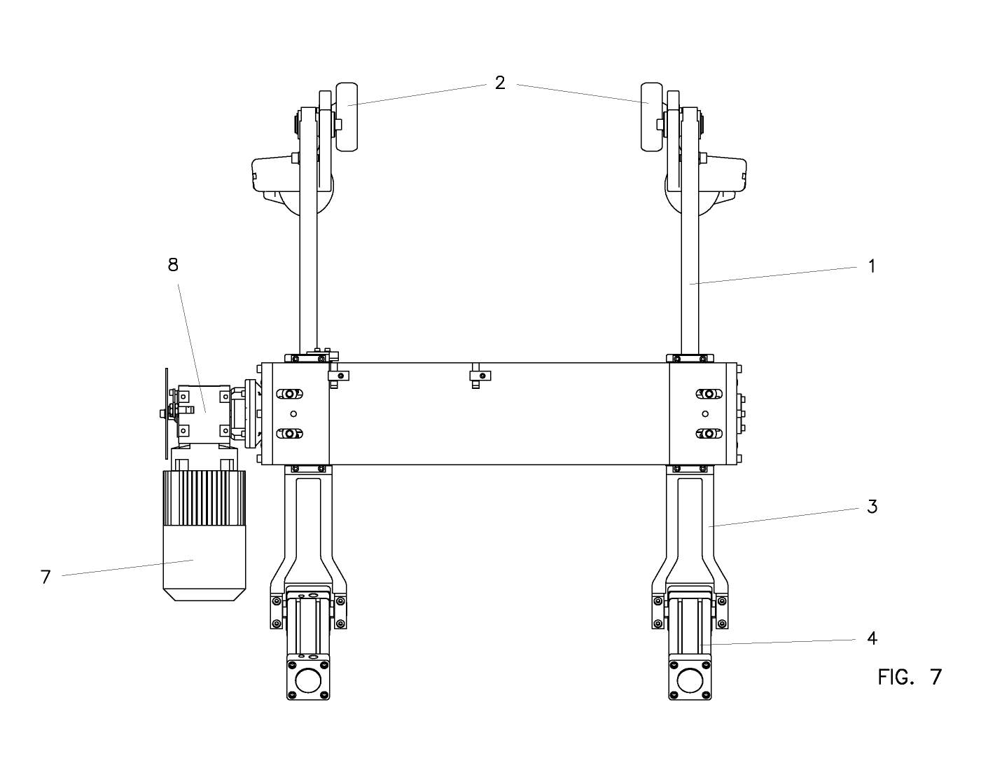

FIGS. 2 to 7 show the rolling device mounted on the frame (Q) comprising arms (1) with end rolls (2), on which the tire is rested on the wheeling position (not shown). The rolls (2) press the new tread against the tire carcass, expelling the air that may have been trapped. The arms (1) are centrally pivoting in transversal gears (3), by the action of hydraulic or pneumatic cylinders (4), allowing to get rolls (2) closer or farther to/from the new tread applied to the tire carcass.

Secondary rolls (5) with semi-spherical shape, are positioned on the arms ends (1) from the outside, and close to the main rolls (2), so as to exert pressure also on the tread sides, next to the tire shoulder.

A horizontal spindle (6) is driven by a motor (7) and reducer (8) set, and is intended to move the arms (1), making the secondary rolls (5) exert pressure against the tire shoulders. The gears (3) are mounted over the bearings (9) sliding on the machine busbars (10), causing the rolls (2) and the secondary rolls (5) to exert pressure throughout the tread, including the shoulders area.

What is claimed is:

1. An arrangement in tire retreading rolling machine for tires recapping, comprising a structure composed of a lower frame provided with adjustable feet and one column on one of its vertices, and column has on its outer side a motoreducer set which rotates a hub positioned on the column inner side, with bearing held to column and supporting the hub shaft, on which the tire to be processed is mounted, wherein it comprises
arms with end rolls, on which the tire is rested on the wheeling position, with the arms centrally pivoting in transversal gears, by the action of cylinders;
secondary rolls with semi-spherical shape, positioned on the arms ends from the outside, and close to the main rolls, so as to press the tread sides, next to the tire shoulder;
a horizontal spindle, driven by a motor and reducer set, to get arms closer to the secondary rolls against the tread and the tire shoulders area;
the transversal gears are mounted over the bearings sliding on the machine busbars.
